(19) United States
(12) Patent Application Publication
(10) Pub. No.: US 2024/0425688 A1
(43) Pub. Date: Dec. 26, 2024

(54) SOFT EVA POLYMERIC COMPOSITIONS AND ARTICLES AND METHODS THEREOF

(71) Applicant: Braskem S.A., Camaçari (BR)

(72) Inventors: Giancarlos Delevati, São Paulo (BR); Juliani Cappra da Silva, São Paulo City (BR)

(73) Assignee: Braskem S.A., Camaçari (BR)

(21) Appl. No.: 18/742,212

(22) Filed: Jun. 13, 2024

Related U.S. Application Data
(60) Provisional application No. 63/472,781, filed on Jun. 13, 2023.

(51) Int. Cl. C08L 23/08; C08J 9/00; C08L 9/10; C08L 53/02

(52) U.S. Cl. CPC C08L 23/0853; C08J 9/0061; C08L 9/10; C08L 53/025; C08J 2309/10; C08J 2323/08; C08J 2353/02; C08J 2409/10; C08J 2453/02; C08L 2203/14; C08L 2205/03

(57) ABSTRACT

A polymer composition may include at least one ethylene-vinyl acetate copolymer and at least one farnesene polymer. A process for producing a polymer composition may include mixing the at least one ethylene-vinyl acetate copolymer with the at least one farnesene polymer, thereby producing the polymer composition that includes at least one ethylene-vinyl acetate copolymer and at least one farnesene polymer.

### BACKGROUND

Commercial rubber compositions may be formulated with a variety of primary and secondary polymers and various additives to tune performance based on the final application. For example, rubber compositions that are normally used in the footwear market require a large number of raw materials in order to achieve the attributes necessary for the application, leading to the production of complex and specialized mixtures.

In addition to complex formulations containing a number of additives, curing and vulcanization may create further constraints, limiting the ability to change formulations or reuse rubbers for different applications. The processing difficulty with traditional rubber bases such as SBR (styrene-butadiene rubber), natural rubber and/or blends of different synthetic or natural rubbers, has motivated the search for alternative base materials having similar or improved properties, such as a low density, sufficient hardness, soft touch and a reduced number of formulation components.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein relate to a polymer composition including at least one ethylene-vinyl acetate copolymer and at least one farnesene polymer. In another aspect, embodiments disclosed herein relate to a process for producing a polymer composition that includes mixing the at least one ethylene-vinyl acetate copolymer with the at least one farnesene polymer, thereby producing the polymer composition that includes at least one ethylene-vinyl acetate copolymer and at least one farnesene polymer.

In another aspect, embodiments disclosed herein relate to an article prepared from a polymer composition that includes at least one ethylene-vinyl acetate copolymer and at least one farnesene polymer.

In another aspect, embodiments disclosed herein relate to an expandable polymer composition that includes a polymer composition that includes at least one ethylene-vinyl acetate copolymer and at least one farnesene polymer; a blowing agent; and a peroxide agent.

In yet another aspect, embodiments disclosed herein relate to an expanded article prepared from an expandable polymer composition that includes a polymer composition that includes at least one ethylene-vinyl acetate copolymer and at least one farnesene polymer; a blowing agent; and a peroxide agent.

In yet another aspect, embodiments disclosed herein relate to a curable polymer composition that includes a polymer composition that includes at least one ethylene-vinyl acetate copolymer and at least one farnesene polymer; and a peroxide agent.

In yet another aspect, embodiments disclosed herein relate to a cured, non-expanded article prepared from a curable polymer composition that includes a polymer composition that includes at least one ethylene-vinyl acetate copolymer and at least one farnesene polymer; and a peroxide agent.

Other aspects and advantages of the claimed subject matter will be apparent from the following description and the appended claims.

### DETAILED DESCRIPTION

Polymer compositions in accordance with the present disclosure may be used for the partial or total replacement of rubbers such as styrene-butadiene rubber to prepare expanded and non-expanded articles in applications including shoe sole components, monobloc expanded soles for sandals or flip-flops, and the like, while retaining the required technical requirements demanded by these applications. Moreover, the polymer compositions may possess low hardness and soft touch, while also optionally having a renewable content.

Polymer compositions in accordance with the present disclosure may include at least one ethylene vinyl acetate copolymer and at least one farnesene polymer; and optionally one or more of filler, blowing agent, curing agent, or blowing accelerator. Each of these

### Polymer Composition

Polymeric compositions in accordance with one or more embodiments of the present disclosure may be prepared from components (A) at least one ethylene-vinyl acetate (EVA) copolymer and (B) at least one farnesene polymer. While particular embodiments of the present disclosure may be directed to use of bio-based EVA copolymers in the production of the elastomeric EVA compositions, it is also understood that one or more other components may also be formed from renewable and/or fossil sources. The components of the elastomer composition of the present disclosure as well as their respective properties are detailed below.

### (A) EVA Copolymer

According to one or more embodiments, the polymeric compositions of the present disclosure may incorporate at least one ethylene-vinyl acetate (EVA) copolymer, thereby incorporating one or more EVA copolymers prepared by the copolymerization of ethylene and vinyl acetate. EVA is a copolymer of the polyolefin family of elastomers formed by the sequence of random units derived from the polymerization of ethylene and vinyl acetate at high temperature and pressure. EVA copolymers provide materials that can be processed like other thermoplastics but may offer a rubbery character having softness and elasticity. The use of EVA copolymers derived from natural sources as well as from fossil sources have been utilized. In one or more embodiments, the EVA copolymer may be obtained from fossil (petrochemical) or renewable sources, also referred to as biobased EVA.

Polymer compositions in accordance with the present disclosure may comprise at least one EVA copolymer at a percent by weight (wt %) of the composition that ranges from 10 to 90 wt %, such as from a lower limit of 10 wt %, 15 wt %, 20 wt %, 25 wt %, 30 wt %, or 40 wt %, to an upper limit of any one of 50 wt %, 60 wt %, 70 wt %, 80 wt %, or 90 wt %, where any lower limit may be paired with any upper limit.

Polymer compositions in accordance with the present disclosure may include EVA copolymers incorporating various ratios of ethylene and vinyl acetate. In one or more embodiments, at least one EVA copolymer may comprise a percent by weight of vinyl acetate in the copolymer, as determined by ASTM D5594, that ranges from 15 to 25 wt %, such as from a lower limit of any one of 15 wt %, 16 wt %, 17 wt %, 18 wt %, or 20 wt %, to an upper limit of any one of 21 wt %, 22 wt %, 23 wt %, 24 wt % or 25 wt %, where any lower limit may be paired with any upper limit. Such EVA copolymer may comprise a percent by weight of ethylene that ranges from a lower limit selected from any one of 75 wt %, 78 wt %, or 80 wt %, to an upper limit selected from one of 80 wt %, 82 wt %, or 85 wt %, where any lower limit may be paired with any upper limit. According to one or more embodiments, the polymer composition may comprise at least one EVA copolymer derived from a bio-based sources, fossil sources, or a mixture of bio-based and fossil sources.

According to one or more embodiments, the polymer composition comprises at least one EVA copolymer comprising ethylene and/or vinyl acetate derived from a renewable carbon source. The renewable sources of carbon include but are not limited to one or more plant materials selected from the group consisting of sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, the at least one EVA copolymer derived from a renewable carbon source may exhibit a bio-based carbon content, as determined by ASTM D6866-18 Method B of at least 5%. Further, other embodiments may comprise at least 10%, 20%, 40%, 50%, 60%, 80%, or 100% bio-based carbon. As mentioned above, any total bio-based or renewable carbon in the at least one EVA copolymer may be contributed from a bio-based ethylene and/or a bio-based vinyl acetate. In one or more embodiments, the polymer composition may exhibit a bio-based carbon content as determined by ASTM D6866-18 Method B in the range of 5 to 90%, such as from the lower limit of 5, 10, 15, 25, and 35% to an upper limit of 70, 80 and 90%, where any upper limit may be paired with any lower limit.

In one or more embodiments, a biobased EVA may be formed from a bio-based ethylene monomer. Bio-based ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Thus, biologically sourced ethanol, known as bio-ethanol, may be obtained by the fermentation of sugars derived from cultures such as that of sugar cane and beets, or from hydrolyzed starch, which is, in turn, associated with other cultures such as corn. It is also envisioned that the bio-based ethylene may be obtained from hydrolysis-based products of cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

Bio-based vinyl acetate, on the other hand, may also be used in one of more embodiments of the present disclosure. Bio-based vinyl acetate may be produced by producing acetic acid by oxidation of ethanol (which may be formed as described above) followed by reaction of ethylene and acetic acid to acyloxylate the ethylene and arrive at vinyl acetate. Further, it is understood that the ethylene reacted with the acetic acid may also be formed from a renewable source as described above.

An exemplary route of obtaining a bio-based vinyl acetate may include, initially, the fermentation and optional purification of a renewable starting material, including those described above, to produce at least one alcohol (either ethanol or a mixture of alcohols including ethanol). The alcohol may be separated into two parts, where the first part is introduced into a first reactor and the second part may be introduced into a second reactor. In the first reactor, the alcohol may be dehydrated in order to produce an alkene (ethylene or a mixture of alkenes including ethylene, depending on whether a purification followed the fermentation) followed by optional purification to obtain ethylene. One of ordinary skill in the art may appreciate that if the purification occurs prior to dehydration, then it need not occur after dehydration, and vice versa. In the second reactor, the alcohol may be oxidized in order to obtain acetic acid, which may optionally be purified. In a third reactor, the ethylene produced in the first reactor and the acetic acid produced in the second reactor may be combined and reacted to acyloxylate the ethylene and form vinyl acetate, which may be subsequently isolated and optionally purified. Additional details about oxidation of ethanol to form acetic acid may be found in U.S. Pat. No. 5,840,971 and Selective catalytic oxidation of ethanol to acetic acid on dispersed Mo—V—Nb mixed oxides. Li X, Iglesia E. Chemistry. 2007; 13 (33): 9324-30.

However, the present disclosure is not so limited in terms of the route of forming acetic acid. Rather, it is also envisioned, that acetic acid may be obtained from a fatty acid, as described in “The Production of Vinyl Acetate Monomer as a Co-Product from the Non-Catalytic Cracking of Soybean Oil”, Benjamin Jones, Michael Linnen, Brian Tande and Wayne Scames, Processes, 2015, 3, 61-9-633. Further, the production of acetic acid from fermentation performed by acetogenic bacteria, as described in “Acetic acid bacteria: A group of bacteria with versatile biotechnological applications”, Saichana N, Matsushita K, Adachi O, Frébort I, Frebortova J. Biotechnol Adv. 2015 Nov. 1; 33 (6 Pt 2): 1260-71 and Biotechnological applications of acetic acid bacteria. Raspor P, Goranovic D. Crit Rev Biotechnol. 2008; 28 (2): 101-24. Further, it is also understood that the production of ethylene used to produce vinyl acetate may also be used to provide the ethylene that is subsequently reacted with the vinyl acetate to form the EVA copolymer of the present disclosure. Thus, for example, the amount of ethanol that is fed to the first and second reactors, respectively, may be vary depending on the relative amounts of ethylene and vinyl acetate being polymerized.

In one or more embodiments, the polymer compositions comprises at least one EVA copolymer, wherein the number average molecular weight (Mn) in kilodaltons (kDa) of the at least one EVA copolymer ranges from 5 kDa to 50 kDa, such as from a lower limit selected from one of 5 kDa, 10 kDa, 20 kDa and 25 kDa to an upper limit selected from one of 30 kDa, 35 kDa, 40 kDa and 50 kDa, where any lower limit may be paired with any upper limit.

In one or more embodiments, the polymer compositions may comprise at least one EVA copolymer, wherein the weight average molecular weight (Mw) in kilodaltons (kDa) of the at least one EVA copolymer ranges from 25 kDa to 180 kDa, such as from a lower limit selected from any one of 25 kDa, 50 kDa, 70 kDa, 90 kDa and 110 kDa to an upper limit selected from any one of 120 kDa, 140 kDa, 150 kDa and 180 kDa, where any lower limit may be paired with any upper limit.

Polymer compositions in accordance with the present disclosure may comprise at least one EVA copolymer, wherein the dispersity (Mw/Mn) of the EVA copolymer ranges from a lower limit selected from any one of 1.0, 1.5, 3.0 and 4.0 to an upper limit selected from any one of 5.0, 6.0, 7.0 and 8.0, where any lower limit may be paired with any upper limit.

The molecular weight properties may be measured by GPC (Gel Permeation Chromatography) experiments. Such experiments may be coupled with triple detection, such as with an infrared detector IR5 and a four-bridge capillary viscometer (PolymerChar) and an eight-angle light scattering detector (Wyatt). A set of 4 mixed bed, 13 μm columns (Tosoh) may be used at a temperature of 140° C. The experiments may use a concentration of 1 mg/mL, a flow rate of 1 mL/min, a dissolution temperature and time of 160° C. and 90 minutes, respectively, an injection volume of 200 μL, and a solvent of trichlorium benzene stabilized with 100 ppm of BHT.

It is also envisioned that there may be more than one EVA copolymer present in the polymer composition. Specifically, it is envisioned that in addition to the EVA copolymer described above, a second EVA copolymer may be optionally included as a rubber component (described below) that has a higher vinyl acetate content than the one described above. Such second EVA copolymer may be either fossil-based or biobased.

### (B) Farnesene Polymer

Farnesene polymers refer to polymers formed from a farnesene monomer:

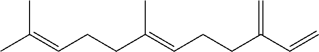

The polymeric compositions of the present disclosure may comprise at least one farnesene polymer at a percent by weight (wt %) of the composition that ranges from 10 to 90 wt %, such as from a lower limit of any one of 10 wt %, 15 wt %, 20 wt %, 25 wt %, 30 wt %, or 40 wt %, to an upper limit of any one of 50 wt %, 60 wt %, 70 wt %, 80 wt %, or 90 wt %, where any lower limit may be paired with any upper limit.

In one or more embodiments, the at least one farnesene polymer may be obtained from a renewable source of carbon. The renewable source of carbon may include any of the above-mentioned renewable sources of carbon. In particular embodiments, the at least one farnesene polymer is formed from a beta-farnesene monomer, which is a renewable monomer derived from sugar cane.

According to one or more embodiments, the at least one farnesene polymer may comprise farnesene homopolymers, farnesene copolymers obtained from farnesene and vinyl monomers, and mixtures thereof. Such farnesene polymers are available, for example from Kuraray.

In one or more embodiments, the at least one farnesene polymer may be farnesene homopolymers that may be present in the polymer composition in a range of 0.1 to 80 wt %, such as from a lower limit of 0.1 wt %, 1 wt %, 5 wt %, 10 wt %, or 20 wt %, to an upper limit of any one of 50 wt %, 60 wt %, 70 wt %, or 80 wt %, where any lower limit may be paired with any upper limit. In one or more embodiments, the farnesene homopolymer may be a liquid farnesene rubber.

In one or more embodiments, the at least one farnesene polymer may be a copolymer of farnesene and the vinyl monomer may be present in the polymer composition in a range of 10 to 90 wt %, such as from a lower limit of 10 wt %, 15 wt %, 20 wt %, 25 wt %, 30 wt %, or 40 wt %, to an upper limit of any one of 50 wt %, 60 wt %, 70 wt %, 80 wt %, or 90 wt %, where any lower limit may be paired with any upper limit.

According to at least one embodiment, the at least one farnesene polymer may be a farnesene copolymer of farnesene and the vinyl monomer styrene, thereby forming a hydrogenated styrene farnesene block copolymer. For example, such farnesene copolymers are described in U.S. Pat. No. 9,353,201, which is herein incorporated by reference in its entirety.

It is also envisioned that in addition to the above described farnesene polymers, other farnesene polymers may also be included as optional rubber components, as described below. In other embodiments, the at least one farnesene polymer may comprise farnesene and butadiene thereby forming a farnesene butadiene random copolymer.

### Optional Rubber Components

The polymer compositions of the present disclosure may optionally further comprise a rubber component to increase the rubbery touch and increase the coefficient of friction, depending on the end use application. Rubbers in accordance with the present disclosure may include but are not limited to, solid or liquid rubbers such as one or more of natural rubber (NR), poly-isoprene (IR), styrene and butadiene rubber (SBR), liquid butadiene rubber (L-BR), liquid isoprene rubber (L-IR), liquid polystyrene-butadiene rubber (L-SBR), polybutadiene (BR), nitrile rubber (NBR); hydrogenated nitrile rubbers (HNBR); polyolefin rubbers such as ethylene-propylene rubbers (EPDM, EPM), EVA, and the like, a farnesene butadiene random copolymer, acrylic rubbers, halogen rubbers such as halogenated butyl rubbers including brominated butyl rubber and chlorinated butyl rubber, brominated isotubylene, polychloroprene, and the like; fluorinated rubbers; thermoplastic rubbers such as elastomers based on styrene, butadiene, isoprene, ethylene and propylene, styrene-isoprene-styrene (SIS), styrene-ethylene-butylene-styrene (SEBS), styrene-butylene-styrene (SBS), styrene-ethylene-propylene-styrene (SEPS) and the like, isobutylene-isoprene rubber (IIR), ester-based elastomers, elastomeric polyurethane, elastomeric polyamide, epichlorohydrin rubber (ECO), polyacrylate rubber (ACM) and the like.

Polymer compositions in accordance with the present disclosure may further comprise a rubber component as above described, at a percent by weight (wt %) of the composition that ranges from 0.5 to 90 wt %, such as from a lower limit of 0.5 wt %, 1 wt %, 5 wt %, 10 wt % or 15 wt % to an upper limit of 20 wt %, 35 wt % 40 wt %, 50 wt %, 75 wt %, or 80 wt %, where any lower limit may be paired with any upper limit.

For example, such rubber components can include one or more of the following components at the indicated weight percents, relative to the polymer composition: EVA with 25% to 45% vinyl acetate at 10% to 90%, preferably 25% to 75%; L-FBR (Farnesene/Butadiene Random Copolymer) at 10% to 90%, preferably 25% to 50%; L-BR (Liquid Butadiene Rubber) at 10% to 90%, preferably 25% to 50%; L-IR (Liquid Isoprene Rubber) at 10% to 90%, preferably 25% to 50%; L-SBR (Liquid Polystyrene-Butadiene Rubber) at 10% to 90%, preferably-25% to 50%; POE (Polyolefin Elastomers) at 5% to 35%, preferably 15% to 25%; OBC (Olefin Block Copolymers) at 5% to 35%, preferably 15% to 25%; SEBS (Styrene-Ethylene/Butylene-Styrene) at 5% to 35%, preferably 10% to 20%; SEPS (Styrene-Ethylene/Propylene-Styrene) at 5% to 35%, preferably 10% to 20%; SBS (Styrene-Butadiene-Styrene) at 5% to 35%, preferably 10% to 20%; SIS (Styrene-Isoprene-Styrene) at 5% to 35%, preferably 10% to 20%; SBR (Styrene-Butadiene Rubber) at 5% to 35%, preferably 10% to 20%; BR (Polybutadiene Rubber) at 5% to 35%, preferably 10% to 20%; IR (Polyisoprene Rubber) at 5% to 35%, preferably 10% to 20%; NBR (Acrylonitrile-Butadiene Rubber) at 5% to 35%, preferably 10% to 20%; HNBR (Hydrogenated Nitrile Rubber) at 5% to 35%, preferably 10% to 20%; NR (Natural Rubber) at 5%-35%, preferably 10%-20%; BR (Butadiene Rubber, Polybutadiene) at 5% to 35%, preferably 10% to 20%; EPM (Ethylene-Propylene Rubber) at 5% to 35%, preferably 10% to 20%; EPDM (Ethylene-Propylene-Diene Rubber) at 5% to 35%, preferably 10% to 20%; IIR (Isobutylene-Isoprene Rubber, Butyl Rubber) at 5% to 35%, preferably 10% to 20%; CR (Polychloroprene, Chloroprene Rubber, Neoprene) at 5% to 35%, preferably 10% to 20%; EVA (Ethylene Vinyl Acetate) with 75% to 85% vinyl acetate at 5% to 35%, preferably 10% to 20%; ECO (Epichlorohydrin Rubber) at 5% to 35%, preferably 10% to 20%; or ACM (Polyacrylate Rubber) at 5% to 35%, preferably 10% to 20%.

Rubbers in accordance with the present disclosure may have a hardness determined in accordance with ASTM D2240 in a range having a lower limit selected from any of 10 Shore A, 15 Shore A, and 20 Shore A, to an upper limit selected from any of 45 Shore A, 50 Shore A, and 55 Shore A, where any lower limit may be paired with any upper limit.

### Filler

Polymeric compositions in accordance with the present disclosure may comprise fillers which may include but are not limited to carbon black, silica powder, calcium carbonate, talc, titanium dioxide, clay, polyhedral oligomeric silsesquioxane (POSS), metal oxide particles and nanoparticles, inorganic salt particles and nanoparticles, recycled EVA, and mixtures thereof.

As defined herein, recycled EVA may be derived from regrind materials that have undergone at least one processing method such as molding or extrusion and the subsequent sprue, runners, flash, rejected parts, and the like, are ground or chopped.

In one or more embodiments, the polymer compositions may comprise one or more fillers at a parts per hundred of polymer composition (phr) that ranges 5 to 220 phr, such as from a lower limit selected from any one of 5 phr, 10 phr, 15 phr, 20 phr, 25 phr, 30 phr, 35 phr, 40 pht, and 55 phr to an upper limit selected from any one of 60 phr, 80 phr, 100 phr, 120 phr, 140 phr, 160 phr, 180 phr, 200 phr, and 220 phr where any lower limit can be used with any upper limit

### Peroxide Agent

Polymer compositions in accordance with the present disclosure may comprise one or more peroxide agents capable of generating free radicals during polymer processing. In one or more embodiments, peroxide agents may include but are not limited to bifunctional peroxides such as benzoyl peroxide; dicumyl peroxide; di-tert-butyl peroxide; 00-Tert-amyl-0-2-ethylhexyl monoperoxycarbonate; tert-butyl cumyl peroxide; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5-dimethyl-2,5-di(tert-butylperoxide)hexyne-3; 3,3,5,7,7-pentamethyl-1,2,4-trioxepane; butyl 4,4-di (tert-butylperoxide) valerate; di(2,4-dichlorobenzoyl) peroxide; di(4-methylbenzoyl) peroxide; peroxide di(tert-butylperoxyisopropyl)benzene; and the like.

Peroxide agents may also comprise benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, butyl-peroxy-2-ethyl-hexanoate, tert-butyl peroxypivalate, tertiary butyl peroxyneodecanoate, t-butyl-peroxy-benzoate, t-butyl-peroxy-2-ethyl-hexanoate, 4-methyl-4-(t-amylperoxy)-2-pentanol,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy) hexane, 2,5-dimethyl-2,5-di(t-amylperoxy)hexane, 2,5-dimethyl-2,5-di(t-butylperoxy)hexyne-3, 2,5-dimethyl-2,5-di(t-amylperoxy)hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobornyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy) vinyl silane, 1,3-dimethyl-3-(t-butylperoxy)butyl N-[1-{3-(1-methylethenyl)-phenyl) 1-methylethyl]carbamate, 1,3-dimethyl-3-(t-amylperoxy)butyl N-[1-{3 (1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy) valerate, ethyl 3,3-di(t-butylperoxy) butyrate, 2,2-di(t-amylperoxy) propane, 3,6,6,9,9-pentamethyl-3-ethoxycabonylmethyl-1,2,4,5-tetraoxacyclononane, n-buty 1-4,4-bis(t-butylperoxy) valerate, ethyl-3,3-di(t-amylperoxy) butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy) hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo) cyclohexane, t-butylperoxy-3,5,5-trimethylhexanoate, t-butyl-peroxy-(cis-3-carboxy) propionate, allyl 3-methyl-3-t-butylperoxy butyrate, OO-t-butyl-O-isopropylmonoperoxy carbonate, OO-t-butyl-O-(2-ethyl hexyl) monoperoxy carbonate, 1,1,1-tris[2-(t-butylperoxy-carbonyloxy) ethoxymethyl]propane, 1,1,1-tris[2-(t-amylperoxy-carbonyloxy) ethoxymethyl]propane, 1,1,1-tris[2-(cumylperoxy-cabonyloxy) ethoxymethyl]propane, OO-t-amyl-O-isopropylmonoperoxy carbonate, di(4-methylbenzoyl) peroxide, di(3-methylbenzoyl) peroxide, di(2-methylbenzoyl) peroxide, didecanoyl peroxide, dilauroyl peroxide, 2,4-dibromo-benzoyl peroxide, succinic acid peroxide, dibenzoyl peroxide, di(2,4-dichloro-benzoyl) peroxide, and combinations thereof.

In one or more embodiments, the polymer composition may comprise one or more peroxide agents. In one or more embodiments, the one or more peroxide agents at a parts per hundred of polymer composition (phr) of that ranges 0.1 to 4 phr, such as from a lower limit selected from one of 0.5 phr, 0.75 phr, 1 phr, 1.5 phr and 2 phr, to an upper limit selected from one of 2.5 phr, 2.75 phr, 3 phr, 3.5 phr and 4 phr, where any lower limit may be paired with any upper limit. Further, it is envisioned that the concentration of the peroxide agent may be more or less depending on the application of the final material.

### Crosslinking Co-Agents

According to one or more embodiments, the polymer compositions may comprise crosslinking co-agents. Crosslinking co-agents create additional reactive sites and increase the rate of crosslinking. Therefore, the degree of polymer crosslinking may be considerably increased from that normally obtained by greater additions of peroxide. Suitable crosslinking co-agents include but are not limited to Triallyl isocyanurate (TAIC), trimethylolpropane-tris-methacrylate (TRIM), triallyl cyanurate (TAC) and combinations thereof.

In one or more embodiments, the polymer compositions in accordance with the present disclosure may comprise one or more crosslinking co-agents at a parts per hundred (phr) that ranges from 0.01 to 2 phr, such as from a lower limit selected from any one of 0.01, 0.25, 0.5 or 1 phr to an upper limit selected from any one of 1.5, 1.75 or 2 phr, where any lower limit may be paired with any upper limit.

### Blowing Agent

Polymeric compositions in accordance with the present disclosure may comprise one or more blowing agents to produce expanded polymeric compositions and foams. Blowing agents may include but are not limited to solid, liquid, or gaseous blowing agents. In embodiments utilizing solid blowing agents, blowing agents may be combined with a polymer composition as a powder or granulate.

Additionally, blowing agents in accordance with the present disclosure include but are not limited to chemical blowing agents that decompose at polymer processing temperatures, releasing the blowing gases such as N₂, CO, CO₂, and the like. Examples of chemical blowing agents may include organic blowing agents, including hydrazines as as such toluenesulfonyl hydrazine, hydrazides such oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical blowing agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

The polymer composition may comprise one or more blowing agents at a parts per hundred polymer composition (phr) that ranges 1 to 6 phr, such as from a lower limit selected from any one of 1, 1.5, 2, 2.5 or 3 phr, to an upper limit selected from one of 3.5, 4, 4.5, 5, 5.5 or 6 phr, where any lower limit may be paired with any upper limit.

### Blowing Accelerators

Polymer compositions in accordance with at least one embodiment of the present disclosure may comprise one or more blowing accelerators (also known as kickers) that enhance or initiate the action of a blowing agent by lowering the associated activation temperature. For example, blowing accelerators may be used if the selected blowing agent reacts or decomposes at temperatures higher than 170° C., such as 220° C. or more, where the surrounding polymer would be degraded if heated to the activation temperature. Blowing accelerators may include any suitable blowing accelerator capable of activating the selected blowing agent. In one or more embodiments, suitable blowing accelerators may include but are not limited to cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like.

In one or more embodiments, polymer compositions in accordance with the present disclosure may comprise one or more blowing accelerators at a parts per hundred polymer composition (phr) that ranges from a lower limit selected from one of 0.1 phr, 0.25 phr, 0.5 phr, 1 phr, 2 phr, and 2.5 phr, to an upper limit selected from one of 1.5 phr, 2 phr, 2.5 phr, 3 phr, 3.5 phr, 4 phr, 4.5 phr and 5 phr, where any lower limit can be used with any upper limit.

### Other Additives

Polymer compositions in accordance with the present disclosure may comprise one or more additives that modify various physical and chemical properties when added to the polymer composition during blending. The one or more additives may include but are not limited to processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents.

### Article Preparation

The present disclosure is also directed to a process of forming articles such as curable polymer compositions, cured expanded and cured non-expanded articles. The process comprises mixing the at least one ethylene-vinyl acetate (EVA) copolymer and the at least one farnesene polymer and producing the polymer composition as described in the embodiments above. Polymer compositions, in accordance with at least one embodiment, may be mixed in any conventional mixture device. In one or more embodiments, polymeric compositions may be prepared by mixture in conventional kneaders, banbury mixers, mixing rollers, twin screw extruders, and the like, in conventional EVA processing conditions and subsequently cured or cured and expanded in conventional expansion processes, such as injection molding or compression molding. Thus, in particular embodiments and as mentioned above, the polymer compositions may be combined with components such as fillers, peroxide agents, crosslinking co-agents, blowing agents, blowing accelerators and other additives to produce expanded or non-expanded cured articles.

In one or more embodiments, the polymer composition, in accordance with the present disclosure may be prepared in a reactor. Ethylene and vinyl acetate are added in a reactor to polymerize. In some embodiments, the ethylene and vinyl acetate are polymerized by high pressure radical polymerization, wherein peroxide agents act as polymerization initiators. In some embodiments, the ethylene and the vinyl acetate, and the peroxide agents are added at elevated pressure into an autoclave or tubular reactor at a temperature of between 80° C. and 300° C. and a pressure inside the reactor between 500 bar and 3000 bar in some embodiments, and a pressure between 1000 bar and 2600 bar in some embodiments. In other embodiments, the copolymers may be produced by a solution polymerization process.

As previously mentioned, the at least one EVA copolymer may comprise at least one of ethylene and/or vinyl acetate monomers derived from renewable sources. The bio-based ethylene may be obtained from an ethanol (through fermentation of sugars or hydrolysis based products from cellulose and hemi-cellulose) that is purified prior to dehydration to remove the higher alcohol byproducts while in other embodiments, the ethylene may be purified to remove the higher alkene impurities after dehydration. As for vinyl acetate, bio-based vinyl acetate may be produced by producing acetic acid by oxidation of ethanol (which may be formed as described above) followed by reaction of ethylene and acetic acid to acyloxylate the ethylene and arrive at vinyl acetate.

Further, it is also understood that upon being mixed with the other components forming the polymer composition, the polymer composition may also be cured for example in the presence of peroxide agent as well, including those discussed above, and optionally, a crosslinking co-agent. Thus, according to one or more embodiments, curable polymer compositions comprising any of the polymer compositions described above may be formed. Additionally, the curable polymer composition may be used to prepare cured non-expanded articles. Therefore, cured articles that comprise a bio-based carbon content, as a result of the curable polymer compositions that comprise the polymer compositions as described above, may exhibit a bio-based carbon content as determined by ASTM D6866-18 Method B, of at least 5%.

For embodiments which include expanded polymer compositions, the expanding and curing may be performed in the presence of a blowing agent and a peroxide agent, and optionally, a blowing accelerator or crosslinking co-agent. During any of such curing steps, in one or more embodiments, the curing may occur in full or partial presence of oxygen, such as described in WO201694161A1, which is incorporated by reference in its entirety.

### Properties of Polymer Compositions

Polymer compositions in accordance with the present disclosure may have good performance as a replacement for rubber materials with acceptable performance at high and low temperatures, with little or no odor, and comparable or lower density to standard rubber formulations. In one or more embodiments, polymer compositions may exhibit high flexibility, suitable hardness, good abrasion resistance, high coefficient of friction, and soft touch. In some embodiments, articles prepared from polymer compositions in accordance with the present disclosure may take the form of cured expanded or cured non-expanded polymer structures.

Polymer compositions in accordance with one or more embodiments of the present disclosure may exhibit a density, as determined by ASTM D-792, ranging from 0.85 to 0.95 g/cm³, such as from a lower limit of 0.85, 0.87, or 0.89 g/cm³ to an upper limit of 0.91, 0.93, or 0.95 g/cm³, where any upper limit may be paired with any lower limit.

Polymer compositions in accordance with one or more embodiments of the present disclosure may exhibit a hardness, as determined by ASTM D2240, in the range of 10 to 80 Shore A, such as from a lower limit of 10, 20, or 30 Shore A to an upper limit of 50, 60, 70 or 80 Shore A, where any upper limit may be paired with any lower limit.

Polymer compositions in accordance with one or more embodiments of the present disclosure may exhibit a hardness, as determined by ASTM D2240, in the range of 5 to 30 Shore D, such as from a lower limit of 5, 10, or 15 Shore D to an upper limit of 20, 25, or 30 Shore D, where any upper limit may be paired with any lower limit.

Polymer compositions in accordance with one or more embodiments of the present disclosure may exhibit a melt flow index (MFI), as determined by ASTM D1238, in the range of 0.2 to 80 g/10 min measured with a load of 2.16 kg at 190° C., such as from a lower limit of 0.2, 1, 5, 10 or 15 g/10 min to an upper limit of 25, 45, 65 or 80 g/10 min, where any upper limit may be paired with any lower limit.

A cured non-expanded article comprising the polymer compositions of the present disclosure may have a density as determined by ASTM D-792 of at least 0.85 g/cm³, or of at least 0.9, 1.0, 1.5 or 2.0 g/cm³.

Cured non-expanded articles prepared by the polymer compositions in accordance with the present disclosure may have a hardness as determined by ASTM D2240 within a range of 20 to 90 Shore A, such as having a lower limit selected from any one of 20, 30, 40, 50, or 60 Shore A, to an upper limit selected from any one of 60, 70, 80, and 90 Shore A, where any lower limit may be paired with any upper limit.

Cured non-expanded articles prepared by the polymer compositions in accordance with the present disclosure may have an abrasion resistance as determined by ISO 4649:2017 measured with a load of 10N within of no more than 700 mm³.

As mentioned above, the polymer compositions may be combined with any of the above-described blowing agents and peroxide agents to form cured and expanded articles. Expanded articles prepared from the polymer compositions in accordance with the present disclosure may have a hydrostatic density as determined by ASTM D-792 within a range of 0.05 to 0.95 g/cm³, such as having a lower limit selected from any one of 0.05 g/cm³, 0.12 g/cm³, 0.15 g/cm³, 0.2 g/cm³, or 0.25 g/cm³, to an upper limit selected from any one of 0.30 g/cm³, 0.5 g/cm³, 0.7 g/cm³ or 0.95 g/cm³ where any lower limit may be paired with any upper limit.

Expanded articles prepared from the polymer compositions in accordance with the present disclosure may have an Asker C hardness as determined by ABNT NBR 14455:2015 in the range of 20 to 90 Asker C, such as having a lower limit of any one of 20, 30, 40 or 45 Asker C and an upper limit of any one of 60, 70, 80, or 90 Asker C, where any lower limit can be paired with any upper limit.

Expanded articles prepared from the polymer compositions in accordance with the present disclosure may have a permanent compression set (PCS) as determined by D395:2018 Method B within a range from 20 to 100%, such as having a lower limit selected from any one of 20%, 30%, 40%, or 50% to an upper limit selected from any one of 60%, 70%, 80%, 90%, or 100% where any lower limit may be paired with any upper limit.

Expanded articles prepared from the polymer compositions in accordance with the present disclosure may have a rebound as determined by ABNT NBR 8619:2015 within a range of 30 to 80%, such as having a lower limit selected from any one of 30%, 35%, 40%, 45%, and 50% to an upper limit selected from any one of 50%, 60%, 70%, and 80%, where any lower limit may be paired with any upper limit.

The PFI method may be used in the industry for shrinkage measurements and is detailed below:

### Equipment:

oven with forced air circulation
pachymeter
ruler for marking of specimens or template
thickness gauge

### Sample

Three specimens of dimensions of at least 100×100 mm should be evaluated of each sample.

### Procedure

The specimens may be conditioned at a temperature of 23±2° C. and a relative humidity of 50±5% for 1 hour. The approximate thickness of the specimens is measured.

Using a ruler or template, the points A, B, C and D are marked on each of the specimens as shown in FIG. 2.

The initial length (Cᵢ) is measured with a pachymeter, to the nearest 0.01 mm, in direction A (segments A-B and C-D) and in the direction B (segments A-C and B-D).

The specimens are then held at 70° C. for 1 hour in a forced air circulation oven.

After the exposure period, the specimens are removed from the oven and conditioned at a temperature of 23±2° C. and a relative humidity of 50±5% for 60 minutes.

The final length (C_{f}) is measured with a caliper, to the nearest 0.01 mm, in direction A (segments A-B and C-D) and direction B (segments A-C and B-D).

The average initial length (Cᵢₘ) is calculated in the A direction as the average of the A-B and C-D segments and in the B direction as the average of the A-C and B-D segments for each of the specimens.

The average final length (C_{fm}) is calculated in the A direction as the average of the A-B and C-D segments and the B direction as the average of the A-C and B-D segments for each of the specimens.

### Results

The shrinkage of the expanded EVA is given by the following equation, expressed as a percentage to the nearest 0.1%.

$$Shrinkage \% = ( {C}_{im} - {C}_{fm} ) \times 100 / {C}_{im}$$

Where:
Cᵢₘ=initial length average (mm)
C_{fm}=final length average (mm)

The final shrinkage result will be calculated for the directions A and B as the average of the shrinkage values calculated for each specimen.

Note: The PFI recommends acceptable maximum values for shrinkage of expanded materials in directions A and B
3% for materials with a density up to 0.6 g/cm³
2% for materials with a density above 0.6 g/cm³

Expanded articles prepared from the polymer compositions in accordance with the present disclosure may have an average shrinkage at 70° C.*1 h using the PFI method (PFI “Testing and Research Institute for the Shoe Manufacturing Industry” in Pirmesens-Germany) within a range of 1.0 to 3.5%, such as having a lower limit selected from any one of 1.0%, 1.5%, 2.0%, 2.5%, 2.7%, and 2.9% to an upper limit selected from any one of 3.1%, 3.3%, and 3.5%, where any lower limit may be paired with any upper limit.

Expanded articles prepared by the polymer compositions in accordance with the present disclosure may have an abrasion resistance as determined by ISO 4649 measured with a load of 5N within a range of 150 to 700 mm3, such as a lower limit selected from one of 150, 250, 350 or 400 mm3, to an upper limit selected from one of 500, 600, 650, 690 and 700 mm3, where any lower limit may be paired with any upper limit.

Expanded articles prepared by the polymer composition in accordance with the present disclosure may have an elongation at break as determined by ASTM D638 that is at least 200%, 300%, 350%, or 400%.

### Applications

As referenced above, the polymer compositions can be used in various molding processes, including extrusion molding, injection molding, compression molding, thermoforming, cast film extrusion, blown film extrusion, foaming, extrusion blow-molding, injection blow-molding, ISBM (Injection Stretched Blow-Molding), pultrusion, 3D printing, rotomolding, double expansion process, and the like, to produce manufactured articles.

Polymer compositions in accordance with the present disclosure may also be formulated for a number of polymer articles, including the production of insoles, midsole, soles, hot-melt adhesives, primers, in civil construction as linings, industrial floors, acoustic insulation. Polymeric compositions in accordance with the present disclosure may be formed into articles used for a diverse array of end-uses including shoe soles, midsoles, outsoles, unisoles, insoles, monobloc sandals and flip flops, and full EVA footwear.

Other applications may include seals, hoses, gaskets, foams, foam mattresses, furniture, electro-electronic, automotive, packaging, EVA tires, bras, mats, paperboards, sportive articles, toys, swimming accessories, legs floats, yoga blocks, dumbbell gloves, gym steps, rodo sheets, kimono strips, sandpapers, finger protectors, wall protectors, finger separators, educational games and articles, decorative panels, EVA balls, twisted Hex stools, slippers, pillow, sponges, seats, cycling bib pad, protective covers, carpets, aprons and others.

### EXAMPLES

In the following examples, polymer compositions were prepared and assayed to study various physical properties.

### Examples 1-3 Production of Polymer Compositions

The EVA copolymers were prepared using SVT2180 (Green Ethylene Vinyl Acetate), Septon Bio (HSFC-hydrogenated styrene farnesene block copolymer from Kuraray), and L-FR-107L (liquid farnesene rubber homopolymer from Kuraray). The polymer compositions were made according to Table 1.

TABLE 1

| | Comp 1 | Comp 2 | Comp 3 | Comp 4 |
|---|---|---|---|---|
| Component | wt % | wt % | wt % | wt % |
| SVT2180 | 50 | 50 | 50 | 34 |
| Septon Bio | 50 | 25 | 0 | 33 |
| L-FR-107L | 0 | 25 | 50 | 33 |

Properties

| Property | Ex 1 | Ex 2 | Ex 3* | Ex 4 |
|---|---|---|---|---|
| Hydrostatic Density g/cm3 | 0.911 | 0.912 | — | 0.907 |
| Shore D Hardness | 16.5 | 6.3 | — | 2.3** |
| Shore A Hardness | 70.1 | 44.8 | — | 9.3** |
| MFI g/10 min | 0.42 | 7.59 | — | 50.33 |
| Tc, ° C. | 47 and 70 | 47 and 70 | — | 47 and 70 |
| Tm, ° C. | 88 | 88 | — | 88 |
| Δ Hc, J/g | 34.4 | 35.2 | — | 23.0 |
| Δ Hm, J/g | 27.6 | 28/7 | — | 18.6 |

*processing of comp 3 was not possible due to fluidity and stickiness at the extruder outlet
**indicates that material does not have sufficient stiffness for Shore D and Shore A hardness evaluation

### Examples 5-7 Preparation of Expanded Articles

Exapanded articles formed from expandable polymeric composition formulations are shown in Table 2.

TABLE 2

| | Ex 5 | Ex 6 | Ex 7 |
|---|---|---|---|
| Components | phr | phr | phr |
| Comp 1 | 100 | | |
| Comp 2 | | 100 | |
| Comp 4 | | | 100 |
| Bis Peroxide | 1.80 | 1.80 | 1.80 |
| 802G | | | |
| AZO | 1.70 | 1.70 | 1.70 |
| ZnO | 1.00 | 1.00 | 1.00 |
| CaCO₃ | 10.00 | 10.00 | 10.00 |
| Stearic Acid | 1.00 | 1.00 | 1.00 |
| Total | 115.50 | 115.50 | 115.50 |

Samples were assayed for hardness (Shore A and Asker C), density, abrasion resistance, compression set, shrinkage, rebound and the results are shown in Table 3.

TABLE 3

| Property | Ex 5 | Ex 6 | Ex 7 |
|---|---|---|---|
| Expansion rate | 40 | 45 | 43 |
| Hydrostatic Density, g/cm³ | 0.3222 | 0.2759 | 0.2995 |
| Asker C Hardness, points | 49.3 | 39.6 | 29.7 |
| Abrasion, mm³ | 460 | 734 | 712 |
| Impact Resilience, % | 43 | 43 | 42 |
| Coeff. of Static Friction, μs | 2,233 | 2,610 | * |
| Coeff. of Kinetic Friction, μk | 2,083 | 2,075 | * |
| Compression Set, % | 36.7 | 40.0 | 37.6 |
| Expanded Shrinkage % A dir | 2.4 | 3.0 | 2.7 |
| Expanded Shrinkage % B dir | 2.6 | 2.9 | 2.8 |

* indicates that it was not possible to split due to stickiness

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

1. A polymer composition, comprising:
at least one ethylene-vinyl acetate copolymer; and
at least one farnesene polymer.

2. The polymer composition of claim 1, wherein at least a portion of the at least one ethylene-vinyl acetate copolymer and the at least one farnesene polymer are obtained from a renewable source of carbon.

3. The polymer composition of claim 1, wherein the at least one farnesene polymer comprises a farnesene homopolymer and a farnesene copolymer of farnesene and at least one vinyl monomer.

4. The polymer composition of claim 3, wherein the vinyl monomer is styrene.

5. The polymer composition of claim 3, wherein the composition comprises:
10 to 90 wt % of the at least one ethylene-vinyl acetate copolymer;
10 to 90 wt % of the farnesene copolymer; and
0.1 to 80 wt % of the farnesene homopolymer.

6. The polymer composition of claim 1, wherein the at least one ethylene-vinyl acetate copolymer comprises vinyl acetate in an amount ranging from 15 to 25 wt %.

7. The polymer composition of claim 1, further comprising a rubber component selected from the group consisting of bio-based rubbers, natural rubbers, polyolefin rubbers, acrylic rubbers, halogen rubbers, fluorinated rubbers, thermoplastic rubbers, ester-based elastomers, elastomeric polyurethane or elastomeric polyamide.

8. The polymer composition of claim 1, wherein the composition exhibits a bio-based carbon content as determined by ASTM D6866-18 Method B in the range of 5 to 90%.

9. The polymer composition of claim 1, wherein the polymer composition has a density, as determined by ASTM D-792, ranging from 0.85 to 0.95.

10. The polymer composition of claim 1, wherein the polymer composition exhibits a hardness as determined by ASTM D2240 in the range of 10 to 80 Shore A or a hardness as determined by ASTM D2240 in the range of 5 to 30 Shore D.

11. The polymer composition of claim 1, wherein the polymer composition exhibits a melt flow index as determined by ASTM D1238 ranging from 0.2 to 80 g/10 min measured with a load of 2.16 kg at 190° C.

12. A process for producing a polymer composition, comprising:
mixing the at least one ethylene-vinyl acetate copolymer with the at least one farnesene polymer thereby producing the polymer composition of claim 1.

13. The process of claim 12, wherein the process further comprises:
curing the polymer composition in the presence of a peroxide agent, or
curing and expanding the polymer composition in the presence of at least a blowing agent and a peroxide agent,
wherein the curing of the polymer composition occurs in a full or partial presence of oxygen.

14. An article prepared from the polymer composition of claim 1, wherein the article is selected from a group consisting of shoe soles, midsoles, outsoles, unisoles, insoles, monobloc sandals, flip flops, full EVA footwear, sportive articles, seals, hoses, gaskets, foams, foam mattresses and automotive parts.

15. An expandable polymer composition comprising the polymer composition of claim 1 and at least a blowing agent and a peroxide agent.

16. An expanded article prepared from the expandable polymer composition of claim 15.

17. The expanded article of claim 16, wherein the expanded article exhibits a hydrostatic density as determined by ASTM D-792 within the range of 0.05 to 0.95 g/cm3 or an Asker C hardness as determined by ABNT NBR 14455:2015 in the range of 20 to 90 Asker C.

18. A curable polymer composition comprising:
the polymer composition of claim 1; and
at least a peroxide agent.

19. A cured non-expanded article prepared from the curable polymer composition of claim 18.

20. The cured non-expanded article of claim 19, wherein the cured article exhibits a density as determined by ASTM D-792 of at least 0.85 g/cm³, or a Shore A hardness as determined by ASTM D2240 in the range of 20 to 90 Shore A, and optionally an abrasion resistance, as determined by ISO 4649:2017 measured with a load of 10N, of no more than 700 mm³.
